(19) United States
(12) Patent Application Publication
(10) Pub. No.: US 2007/0068955 A1
(43) Pub. Date: Mar. 29, 2007

(54) Cookware device

(75) Inventors: Joel Tetreault, Haskins, OH (US); Paul Angelo LoGiudice, Toledo, OH (US); Steve Muske, Statesville, NC (US)

Correspondence Address: FOLEY AND LARDNER LLP;SUITE 500, 3000 K STREET NW, WASHINGTON, DC, 20007, US

(73) Assignee: Calphalon Corporation

(21) Appl. No.: 11/237,877

(22) Filed: Sep. 29, 2005

(51) Int. Cl. A47J 37/01

(52) U.S. Cl. 220/573.1

(57) ABSTRACT

A cookware device comprises separable cooking vessels that can be releasably attached to form a securely joined sealed chamber that can be flipped during food preparation and cooking. Each cooking vessel comprises a cooking chamber, a grip handle and a lock handle. The lock handle of the top vessel is configured to be positioned into an open area of the lock handle of the bottom vessel to interlock the handles and create a point of tension. The grip handles are configured to not interfere with each other so that when the vessels are attached, the grip handles do not prevent a sealed chamber from forming.

### FIELD OF THE INVENTION

The present invention relates to cookware devices using separate cooking vessels with separable and interlocking handles.

### BACKGROUND

Conventional cookware devices include a cooking chamber with a grip handle. If a chef wishes to cook a frittata or other similar food item in which one side of the food dish is cooked on one side before the chef must flip over the food dish so that it can continue cooking on a second side. Conventional cookware devices for frittatas, omelets or other similar dishes incorporate two separate cooking vessels, with a second cooking vessel positioned in an inverted position over the first cooking vessel. In order to flip the food, the cooking vessels are flipped over and the food can spill out between the two cooking vessels as the two separate cooking vessels separate or slip apart.

Another drawback of conventional cookware devices is that the grip, or long, handles on each separate cooking vessel are incompatible with each other when the second cooking vessel is inverted and placed onto the first cooking vessel. Such interference in conventional designs can lead to leakage of the food while cooking.

Other conventional cookware devices have incorporated wire stock to form loops that interlock with each other and hold two cooking vessels together. A drawback of such conventional cookware devices is that the top cooking vessel is unusable on its own due to the location and design of the wire loop handles.

### SUMMARY OF THE INVENTION

According to one embodiment of the invention, a cookware device is provided. The cookware device comprises a bottom cooking vessel comprising a bottom cooking chamber with a bottom lock handle and a bottom grip handle; and a top cooking vessel comprising a top cooking chamber with a top lock handle and a top grip handle. The top lock handle and bottom lock handle are configured to interlock, whereby the top cooking vessel is releasably attachable to the bottom cooking vessel. The bottom cooking chamber has a rim portion that is configured to align with a rim portion of the top cooking chamber when the top cooking chamber is inverted and placed onto the bottom cooking chamber. When the lock handles interlock and the rim portions are aligned, the bottom cooking chamber and the top cooking chamber form a sealed cooking area. When the top cooking vessel is attached to the bottom cooking vessel, a gap is formed between the top grip handle and the bottom grip handle. According to another embodiment of the invention, a cookware device is provided. The cookware device comprises a bottom cooking vessel comprising a bottom cooking chamber with a bottom lock handle and a bottom grip handle; and a top cooking vessel comprising a top cooking chamber with a top lock handle and a top grip handle. The top cooking vessel is configured to be inverted and releasably attached to the bottom cooking vessel by the positioning of the top lock handle inside an open area of the bottom lock handle to interlock the lock handles. The bottom cooking chamber has a rim portion that is configured to align with a rim portion of the top cooking chamber when the top cooking chamber is inverted and placed onto the bottom cooking chamber.

It is to be understood that both the foregoing general description and the following detailed description are exemplary and exemplary only, and are not restrictive of the invention as claimed.

### BRIEF DESCRIPTION OF THE DRAWINGS

In the drawings:

FIG. 1 is a top perspective view of an embodiment of a cookware device according to the invention in which a top cooking vessel and a bottom cooking vessel are aligned and interlocked together.

FIG. 2 is a top perspective view of the cookware device of FIG. 1 in which the top cooking vessel and bottom cooking vessel are separated.

FIG. 3 is a side view of the cookware device of FIG. 1 as the top cooking vessel is inverted and lock handles begin to be aligned.

FIG. 4 is a side view of the cookware device of FIG. 1 as the lock handle of the top cooking vessel is inserted into an open area of the lock handle of the bottom cooking vessel.

FIG. 5 is a side view of the cookware device of FIG. 1 as the top and bottom lock handles begin to interlock.

FIG. 6 is a side view of the cookware device of FIG. 1 as the top cooking vessel is nearing a fully interlocked position with the bottom cooking vessel.

FIG. 7 is a side view of a cookware device of FIG. 1 in which the top cooking vessel and bottom cooking vessel are fully aligned and interlocked together.

FIG. 8 is a detail perspective view of the lock handles in the interlocked position.

FIG. 9 is a detail perspective view of the grip handles of the top and bottom cooking vessels.

### DETAILED DESCRIPTION

Hereinafter, embodiments of the present invention will be described with reference to the attached drawings.

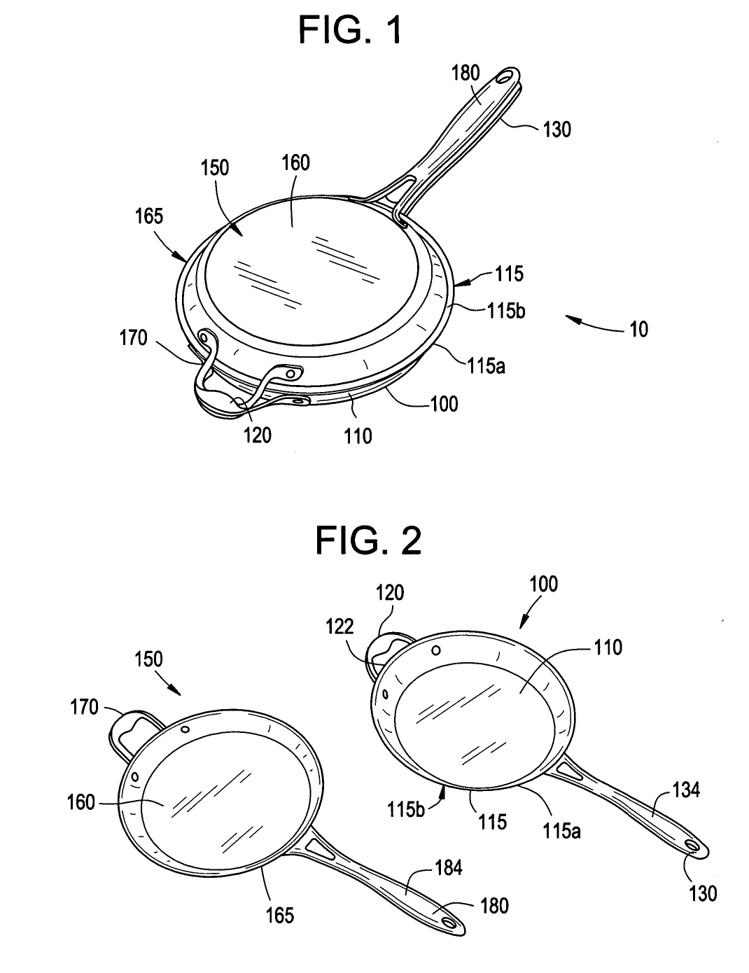

FIGS. 1-9 illustrate a cookware device according to an embodiment of the invention. The cookware device 10 of FIG. 1 includes a bottom cooking vessel 100 and a top cooking vessel 150. The bottom cooking vessel 100 and top cooking vessel 150 can be used interchangeably (i.e., the bottom vessel can be used as a top vessel and the top vessel can be used as a bottom vessel).

The top cooking vessel 150 is configured to releasably attach to the bottom cooking vessel 100 such that the top cooking vessel 150 acts like a cover and/or an additional cooking surface and the cookware device 10 can be flipped over, allowing food items to be cooked on both sides without spilling any food. For example, the cookware device 10 can be used to cook frittatas or omelets or other similar food items. A frittata is a food dish comprising eggs and other ingredients, such as peppers, potatoes and onions. A frittata is almost fully cooked on one side before it is flipped over to finish cooking on a second side. Of course, any other food item can be cooked in the cookware device 10.

The cookware device 10 is comprised of two separable cooking vessels, the bottom cooking vessel 100 and the top cooking vessel 150, as can be seen in FIG. 2. Each cooking vessel 100, 150 is configured to be detachable from each other and can be separately used for cooking independent of the other vessel. When used together, the top cooking vessel 150 is inverted and releasably attached to the bottom cooking vessel 100. When used separately, a cover (not shown) can be used with the cooking vessels 100, 150.

The bottom cooking vessel 100 comprises a bottom cooking chamber 110, a bottom lock handle 120 and a bottom grip handle 130. The bottom grip handle 130 is positioned on an opposite side of an outer surface of the cooking chamber 110 as the bottom lock handle 120. The bottom lock handle 120 includes an open area 122, as seen in FIG. 2. The bottom cooking chamber 110 includes a rim portion 115 that extends along the circumference of the top rim. The bottom cooking chamber 110 can have a concave shape, or any other suitable shape.

The top cooking vessel 150 comprises a top cooking chamber 160, a top lock handle 170, and a top grip handle 180. The top grip handle 180 is positioned on an opposite side of an outer surface of the cooking chamber 160 as the top lock handle 170. The top cooking chamber 160 includes a rim portion 165 that extends along the circumference of the top rim. The top cooking chamber 160 can have a concave shape, or any other suitable shape.

The cooking chambers 110, 160 are the areas in which food items are placed for cooking. The cooking chambers 110, 160 can be composed of stamped aluminum with a nonstick coating (such as, for example, Teflon), a stamped aluminum without a coating, stamped stainless steel, any other stamp or cast-grade metal, copper, any sheet metal that can be formed, or any other suitable material. A single cooking area is formed when the bottom cooking chamber 110 is sealed together with the top cooking chamber 160. Alternatively, any other suitable number of cooking areas can be formed.

The grip handles 130, 180 and lock handles 120, 170 can be composed of stainless steel, any cast-grade metal, a plastic or phenolic material, or any other suitable material. The grip handles 130, 180 and lock handles 120, 170 can be riveted to the cooking chambers 110, 160. Alternatively, the grip handles 130, 180 and lock handles 120, 170 can be formed or stamped metal or any other suitable material or form of construction. The grip handles 130, 180 and lock handles 120, 170 can be stationary handles that are not configured to move in relation to the cooking chambers 110, 150. Alternatively, the grip handles 130, 180 and lock handles 120, 170 could be configured to be movable in relation to the cooking chambers 110, 150.

The rim portion 165 of the top cooking chamber 160 is configured to be substantially flat. The rim portion 115 of the bottom cooking chamber includes a flare section 115a forming a groove 115b in the rim portion 115 such that the when the top cooking chamber 160 is inverted and placed onto the bottom cooking chamber 110, the rim portions 115, 165 are aligned and the rim portion 165 of the top cooking chamber 160 fits into the groove 115b.

The bottom cooking chamber 110 and the top cooking chamber 160 are configured to be sealed together when the rim portion 165 of the top cooking chamber 160 is aligned with the rim portion 115 of the bottom cooking chamber 110 and the cooking vessels 100, 150 are attached. The bottom and top cooking chambers 110, 160 can be sealed such that no food item will leak out of the cooking chambers 110, 160. When a force F is applied to the bottom and top grip handles 130, 180, squeezing the grip handles together 130, 180, the rim portions 115, 165 and cooking chambers 110, 160 are further secured and sealed together, such as shown in FIG. 7.

The bottom grip handle 130 and the top grip handle 180 are configured to be compatible with each other when the bottom and top cooking vessels 100, 150 are attached such that there is no interference between the bottom grip handle 130 and the top grip handle 180. When the top cooking vessel 150 is inverted and attached to the bottom cooking vessel 100, the grip handles 130, 180 come in close proximity to each other, but should not interfere with each other. The grip handles 130, 180 should not touch unless a force F is applied to the grip handles 130, 180, forcing them together. Force F does not necessarily need to make the grip handles 130, 180 contact each other.

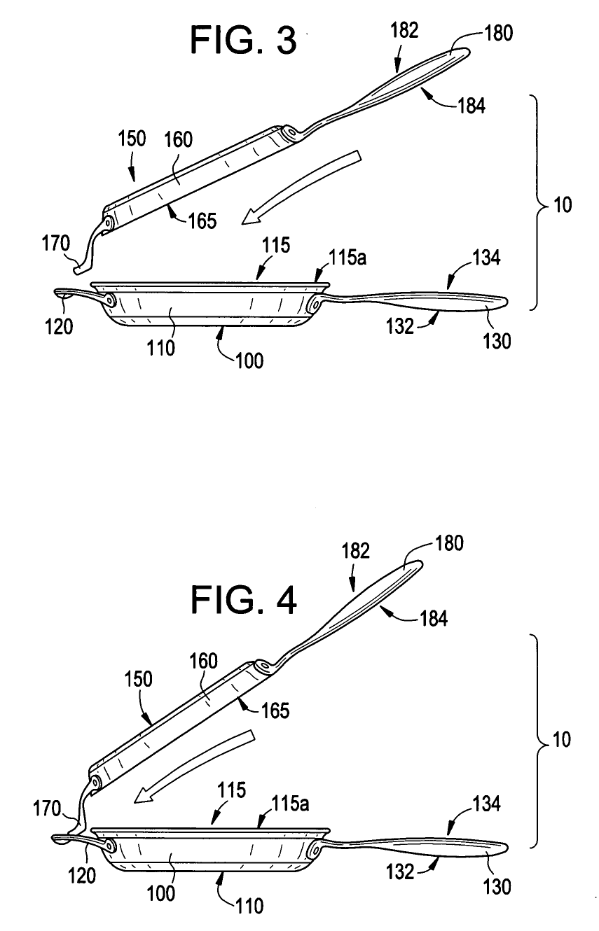

The bottom grip handle 130 has a first surface 132 and a second surface 134. The first surface 132 is the underside surface, as shown in FIGS. 3 and 9. The first surface 132 of the bottom grip 130 is configured to be substantially more curved than the second or opposite surface 134 of the bottom grip handle 130.

The top grip handle 180 has a first surface 182 and a second surface 184. The first surface 182 is the topside surface when the top cooking vessel 160 is inverted, such as shown in FIGS. 3 and 9. The first surface 182 of the top grip handle 180 is configured to be substantially more curved than the second or opposite surface 184 of the top grip handle 180. When the top cooking vessel 150 is inverted and attached to bottom cooking vessel 100, the second surface 184 of the top grip handle 180 is adjacent to the second surface 134 of the bottom grip handle 130.

When the top cooking vessel 150 is attached to the bottom cooking vessel 100, a gap or clearance is formed between the second surface 184 of the top grip handle 180 and the second surface 134 of the bottom grip handle 130. The second surface 134 of the bottom grip handle 130 and the second surface 184 of the top grip handle 180 slope towards the other at distal ends of the grip handles 130, 180 when the top cooking vessel 150 is attached to the bottom cooking vessel.

The gap between the grip handles 130, 180, according to an embodiment, is in the range of 0 to ½″. According to another embodiment, the gap is in the range of 1/100″ to ¼″. In another embodiment, the gap is in the range of 1/16″ to ⅙″. In yet another embodiment, the gap is approximately ⅛″.

In another embodiment, the first surface 132 and the second surface 134 of the bottom grip handle 130 can be equally curved or flat. In yet another embodiment, the first surface 182 and the second surface 184 of the top grip handle 180 can be equally curved or flat. The grip handles 130, 180 can comprise any suitable shape that does not require the grip handles 130, 180 to interfere with one another.

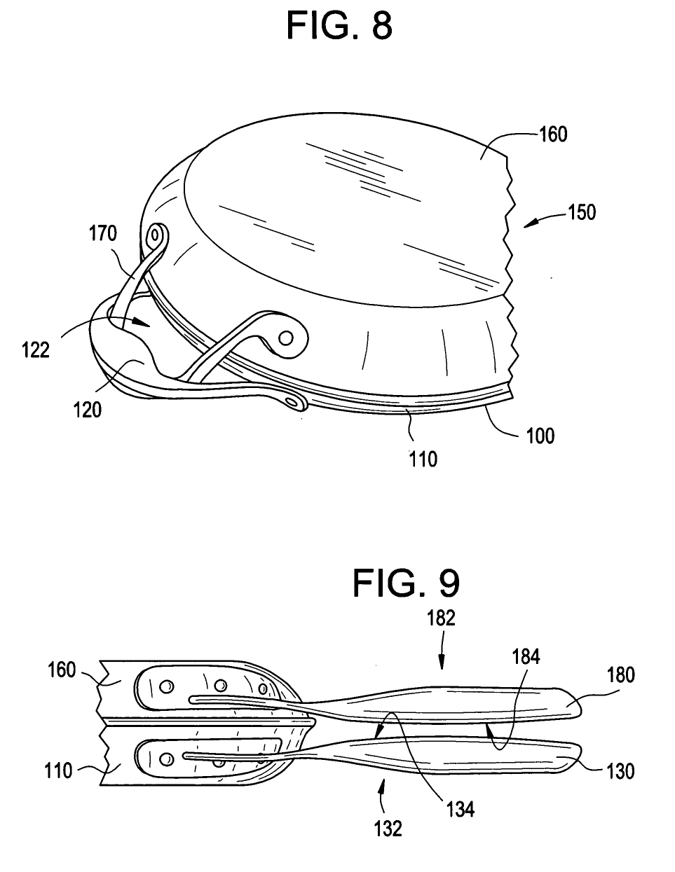

When the top cooking vessel 150 is attached to the bottom cooking vessel 100, a portion of the top lock handle 170 is positioned inside the open area 122 of the bottom lock handle 120 to interlock the lock handles 120, 170, as can be seen in FIGS. 7 and 8. A pivot point P is created at the location where the top lock handle 170 touches the bottom lock handle 120 when the top lock handle 170 is interlocked with the bottom lock handle 120, as can be seen in FIG. 7.

The top lock handle 170 is configured to be narrower than the bottom lock handle 120 such that the top lock handle 170 can be positioned in the open area 122 of the bottom lock handle. The bottom lock handle 120 can be shorter in length than the top lock handle 170. When the cooking vessels 100, 150 are attached and the lock handles 120, 170 interlocked, the top lock handle 170 is inserted into the open area 122 of the bottom lock handle 120 such that a portion of the top lock handle 170 is positioned underneath and in contact with a portion of the bottom lock handle 120.

FIGS. 2-7 illustrate how the top cooking vessel 150 is attached to the bottom cooking vessel 100 of the cookware device 10. As shown in FIG. 2, the top cooking vessel 150 is separated from the bottom cooking vessel 100 such that each cooking vessel 100, 150 may be used independently for cooking. FIG. 3 illustrates the top cooking vessel 150 being picked up and inverted while the top lock handle 170 begins to align with the bottom lock handle 120.

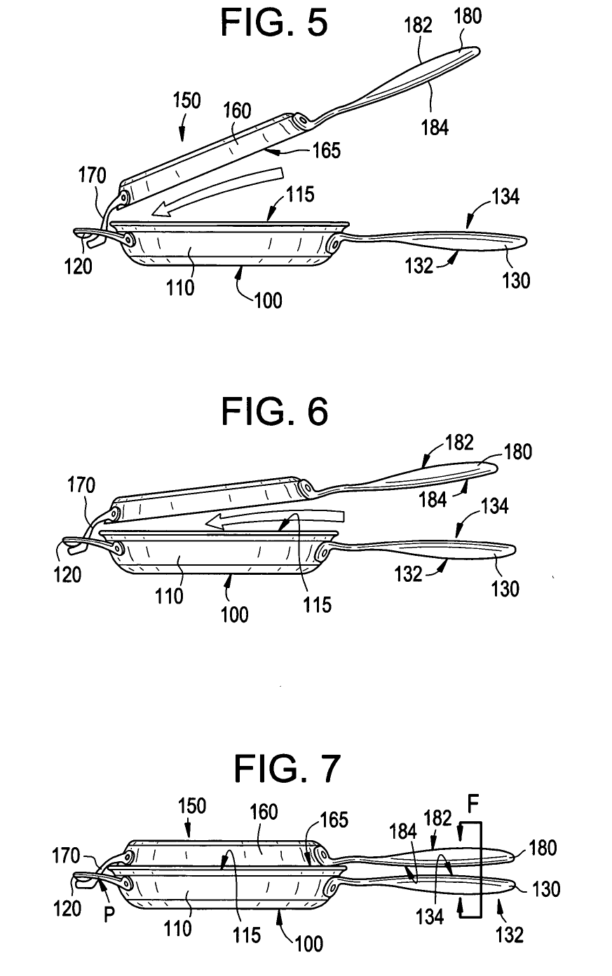

In FIG. 4, the top lock handle 170 is inserted into the open area 122 of the bottom lock handle 120. FIG. 5 shows how the top cooking vessel 150 begins to align with the bottom cooking vessel 100. The lock handles 120, 170 begin to nest together and interlock.

FIG. 6 illustrates the cookware device 10 as the top cooking vessel 150 is nearing full alignment with the bottom cooking vessel 100 such that the rim portions 115, 165 are nearing full alignment. The lock handles 120, 170 begin to touch and begin to form a point of tension. FIG. 7 illustrates the cookware device 10 in full alignment as the top cooking vessel 150 is aligned with the bottom cooking vessel 100.

Of course, it will be recognized that the lock handles 120, 170, the grip handles 130, 180, the cooking chambers 110, 160 and rim portions 115, 165 can have any suitable shape.

A “handle” can be defined as a part by which an object (such as, for example, a cooking vessel) can be held and/or carried by hand.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A cookware device comprising:
a bottom cooking vessel comprising a bottom cooking chamber with a bottom lock handle and a bottom grip handle; and
a top cooking vessel comprising a top cooking chamber with a top lock handle and a top grip handle,
wherein the top lock handle and bottom lock handle are configured to interlock, whereby the top cooking vessel is releasably attachable to the bottom cooking vessel, and
wherein the bottom cooking chamber has a rim portion that is configured to align with a rim portion of the top cooking chamber when the top cooking chamber is inverted and placed onto the bottom cooking chamber,
wherein when the lock handles interlock and the rim portions are aligned, the bottom cooking chamber and the top cooking chamber form a sealed cooking area, and
wherein when the top cooking vessel is attached to the bottom cooking vessel, a gap is formed between the top grip handle and the bottom grip handle.

2. The cookware device of claim 1, wherein the bottom cooking vessel and the top cooking vessel are configured to be detachable from each other and separately usable for cooking.

3. The cookware device of claim 1, wherein a single cooking area is formed when the bottom cooking chamber is sealed together with the top cooking chamber.

4. The cookware device of claim 1, wherein the rim portion of the top cooking chamber is substantially flat.

5. The cookware device of claim 4, wherein the rim portion of the bottom cooking chamber includes a flare section forming a groove in the rim such that the rim portion of the top cooking chamber fits inside the groove.

6. The cookware device of claim 1, wherein a first surface of the bottom grip handle is substantially more curved than a second, opposite surface of the bottom grip handle.

7. The cookware device of claim 6, wherein a first surface of the top grip handle is substantially more curved than a second, opposite surface of the top grip handle.

8. The cookware device of claim 7, wherein when the top cooking vessel is attached to the bottom cooking vessel, the second surface of the top grip handle is adjacent to the second surface of the bottom grip handle.

9. The cookware device of claim 7, wherein the second surface of the bottom grip handle and the second surface of the top grip handle are configured to slope towards the other at distal ends of the grip handles when the top cooking vessel is attached to the bottom cooking vessel.

10. The cookware device of claim 1, wherein the top lock handle is configured to be narrower than the bottom lock handle such that the top lock handle can be positioned in an open area of the bottom lock handle.

11. The cookware device of claim 10, wherein the bottom lock handle is shorter than the top lock handle.

12. The cookware device of claim 11, wherein when the cooking vessels are attached, the top lock handle is inserted into the open area of the bottom lock handle such that a portion of the top lock handle is positioned underneath and in contact with a portion of the bottom lock handle.

13. The cookware device of claim 1, wherein the bottom grip handle is positioned along an outer surface of the bottom cooking chamber opposite to the bottom lock handle.

14. The cookware device of claim 1, wherein the top grip handle is positioned along an outer surface of the top cooking chamber opposite to the top lock handle.

15. The cookware device of claim 1, wherein the grip handles are stationary.

16. The cookware device of claim 1, wherein the bottom cooking chamber and the top cooking chamber have a concave shape.

17. A cookware device comprising:
a bottom cooking vessel comprising a bottom cooking chamber with a bottom lock handle and a bottom grip handle; and
a top cooking vessel comprising a top cooking chamber with a top lock handle and a top grip handle,
wherein the top cooking vessel is configured to be inverted and releasably attached to the bottom cooking vessel by the positioning of the top lock handle inside an open area of the bottom lock handle to interlock the lock handles, and
wherein the bottom cooking chamber has a rim portion that is configured to align with a rim portion of the top cooking chamber when the top cooking chamber is inverted and placed onto the bottom cooking chamber.

18. The cookware device of claim 17, wherein when the top cooking vessel is configured to be secured to the bottom cooking vessel when the lock handles are locked together and a force is applied to the grip handles, squeezing the grip handles towards each other.

19. The cookware device of claim 17, wherein a pivot point is created at the location where the top lock handle touches the bottom lock handle when the top lock handle interlocks with the bottom lock handle.

20. The cookware device of claim 17, wherein when the lock handles interlock and the rim portions are aligned, the bottom cooking chamber and the top cooking chamber form a sealed cooking area.

21. The cookware device of claim 20, wherein a single cooking area is formed when the bottom cooking chamber is sealed together with the top cooking chamber.

22. The cookware device of claim 17, wherein the grip handles are stationary.

23. The cookware device of claim 17, wherein the bottom cooking chamber and the top cooking chamber have a concave shape.

24. The cookware device of claim 17, wherein the bottom cooking vessel and the top cooking vessel are configured to be detachable from each other and separately usable for cooking.
